(19) United States
(12) Patent Application Publication
(10) Pub. No.: US 2024/0240736 A1
(43) Pub. Date: Jul. 18, 2024

(54) ROTARY UNION

(71) Applicant: DEUBLIN GMBH, Mainz (DE)

(72) Inventors: Eberhard Grimm, Wiesbaden (DE); Marcel Skipas, Wiesbaden (DE); Christoph Budzus, Elz (DE)

(21) Appl. No.: 18/559,279

(22) PCT Filed: Apr. 26, 2022
(86) PCT No.: PCT/EP2022/061116

§ 371 Date: Nov. 6, 2023

(30) Foreign Application Priority Data
May 5, 2021 (DE) 102021111688.0
May 5, 2021 (DE) 102021111690.2
Dec. 3, 2021 (DE) 102021131994.3
Dec. 3, 2021 (DE) 102021131995.1

(51) Int. Cl. F16L 27/08; F16J 15/34

(52) U.S. Cl. CPC F16L 27/082; F16J 15/3448; F16L 27/0828

(57) ABSTRACT

A rotary union for transferring fluid media from a stationary machine part to a rotating machine part includes a stationary housing part having a working space and at least one media inlet channel, to introduce fluid media into the stationary housing part, a rotor having a fluid channel for a fluidic connection to the working space, a mechanical seal between the stationary housing part and the rotor including a rotor seal ring that rotates with the rotor, and an axially movable seal ring assembly having a stator seal ring, an elastomer shape-recovery element which, upon pressurization with liquid medium, is pressed axially against a wall of the stationary housing part and deforms elastically, and wherein the elastomer shape-recovery element resiliently recovers its shape upon depressurization and presses away from the wall and in the process pulls the seal ring assembly away from the rotor, opening the mechanical seal.

### CROSS REFERENCES

This application is a U.S. National Phase Application of International Application No. PCT/EP2022/061116 filed on 26 Apr. 2022, which claims priority to German Application Nos. DE 10 2021 111 688.0 and DE 10 2021 111 690.2, each filed on 5 May 2021, and DE 10 2021 131 994.3 and DE 10 2021 131 995.1, each filed on 3 Dec. 2021, the disclosures of each of which are hereby incorporated by reference herein in their entireties.

### TECHNICAL FIELD

The present disclosure relates in general to a rotary union or rotary feedthrough for transferring fluid media from a stationary machine part to a rotating machine part, and in particular to a rotary union in which a stator seal ring assembly having what is known as a floating seal ring of an axial mechanical seal having a secondary seal is axially displaceably mounted and sealed in a stationary housing part.

### BACKGROUND

Rotary unions are typically used for feeding fluid media into a rotating machine part, e.g. a rotating spindle of a machine tool. For this purpose, the rotary union contains a seal between stationary components and rotating components. This seal can be designed as an axial mechanical seal. Typically, in the case of an axial mechanical seal, two slide rings or sliding seal rings slide on one another, wherein one of the seal rings rotates relative to the other, coaxially to the axis of rotation, and the seal rings seal against one another, by their opposing, mutually adjoining, annular end faces, in order to seal the interior, pressurized with a fluid medium, against the atmospheric pressure in the outside region. The type of the fluid media to be transferred by means of the rotary union can vary and in particular include compressible media, such as gases, e.g. compressed air, and liquid media, such as cooling lubricants (CL), and oils, such as cutting oil or hydraulic oil. Cooling lubricant usually consists substantially of an oil-in-water emulsion and typically has a viscosity which is not very much greater than the viscosity of pure water, i.e. a relatively low viscosity. In contrast, cutting oil and hydraulic oil have a significantly higher viscosity, which can be up to 60 mm²/s (cSt) or more. A likewise known method is what is known as reduced or minimum quantity lubrication (RQL/MQL). This typically uses an aerosol in the form of an oil-gas mixture, i.e. substantially also a compressible medium.

There is a plurality of rotary unions in existence which are usually more or less optimized for one or a few particular ones of the above-mentioned fluid media, and/or for particular ranges of allowable operating parameters. Although rotary unions are also known which can be operated using different fluid media having different properties or viscosities, it has been found that these are sometimes not universal or reliable to the desired extent. For example, under certain conditions and/or in the case of some media under some circumstances, for example at high rotational speeds, these can overheat, which can lead even to destruction of the rotary union. Inter alia it has been found that some allegedly universal rotary unions may exhibit significant problems with respect to stability, for example in dry running or with compressed air, at high rotational speeds. Dry running typically refers to the rotating operation of a rotary union without pressurization with a medium.

Furthermore, conventional rotary unions may sometimes have a relatively high leakage rate in compressed-air operation, e.g. of up to 100 standard liters per minute, or more, which may also be undesirable.

Moreover, in the case of some known conventional rotary unions, the response characteristic in the case of pressure and/or media change, or when opening and closing the mechanical seal, can still be improved.

A further disadvantage of some rotary unions can be high installation complexity for the user, in particular if the rotary union is to be pressurized alternately with different media. Sometimes, a complex external fluid connection by the user is required for this.

Furthermore, in the case of such fluid connections, a residual pressure may remain in some regions of the rotary union, which pressure may not be completely released and may lead to undesired operating conditions, e.g. in dry running, up to friction of the seal rings.

A further disadvantage of some rotary unions is that the aerosol of a reduced or minimum quantity lubrication may, at some points of the rotary union, demix, in an undesired manner. Furthermore, the aerosol of a reduced or minimum quantity lubrication may possibly not be able to be sufficiently evacuated or emptied, and, over time, demixed liquid fractions of the aerosol may accumulate in the rotary union.

Some rotary unions use opening or closing spring elements for the mechanical seal, in order to influence the contact pressure of the seal rings against one another. This may also prove disadvantageous under certain operating conditions. For example, spring forces are substantially constant, and do not correlate with the medium pressure. Furthermore, spring elements are additional components which incur costs and are susceptible to faults.

In the patents EP 1 744 502 B1 and EP 2 497 978 B1 by the Deublin Company, a technology is described in which the balance ratio of the mechanical seal is in a specially preselected interval, and a suitable contact pressure between the two seal rings is ensured in a wide pressure and rotational speed range. The technology by Deublin is also known among experts under the designation AutoSense®.

Overall, a plurality of the commercially available conventional rotary unions is limited to a greater or lesser extent, in various ways, in view of the entirety of the sometimes contradictory requirements placed on rotary unions, such as area of use of the operating parameters, variety with respect to the useable fluid media, stability, simplicity for the user, universality, etc. In other words, although known conventional rotary unions are well-suited for certain fields of use, they can nonetheless be further improved in various directions, in particular with respect to their universality, stability, and user-friendliness.

### SUMMARY

The object of the present disclosure is that of providing a rotary union which allows for quick and reliable opening and closing of the mechanical seal.

A further aspect of the object is that of providing a rotary union having an axially movable seal ring assembly or having what is known as a floating seal ring, which operates in a durable and low-wear manner, even during operation at high rotational speeds with pressurized media on the one hand, and in dry running on the other hand, and ensures a quick and reliable detachment of the seal rings from one another (improved Pop-Off® function), in particular in the case of depressurization.

A further aspect of the object is that of providing a rotary union which does not have the disadvantages described above, or has them only to a small degree.

According to one aspect of the present disclosure, a multimedia-compatible rotary union for transferring different fluid media, including both compressible and incompressible media, and media having different viscosities in the same rotary union, from a stationary machine part to a rotating machine part, is provided. The rotary union comprises a stationary housing part for installation in the stationary machine part, and a rotor for connection to the rotating machine part. The stationary housing part comprises a working space or axial or central inner fluid channels, and the rotor, e.g. in the form of a hollow shaft, comprises a likewise in particular axial or central fluid channel, wherein the fluid channels are in fluidic connection with one another even during rotation, in order to establish a continuous fluidic connection between the stationary housing part and the rotor. The stationary housing part can be formed in one piece or in multiple parts.

The rotary union further comprises an axial mechanical seal or end-face mechanical seal between the stationary housing part and the rotor, which seals the fluidic connection between the rotor and the stationary housing part during the rotation. For this purpose, the mechanical seal comprises a slide ring or sliding seal ring that rotates together with the rotor, known as the rotor seal ring, and a non-rotating slide ring or sliding seal ring, known as the stator seal ring. In order that the mechanical seal can open in a controlled manner in dry running without pressure or in compressed-air operation, at least one of the two seal rings is suspended so as to be slightly axially movable. For this purpose, the seal ring is fastened to an axially movably mounted seal ring carrier, and the mechanical seal can open and close by axial movement of the seal ring carrier with the seal ring fastened thereon. From a structural perspective, it is usually easier to suspend the stator seal ring in an axially movable manner. In this case, the axially movable seal ring carrier, together with the stator seal ring fastened thereon, forms an axially movable stator seal ring assembly. The stator seal ring assembly is mounted so as to be axially displaceable, and preferably having some angular play, in the inner fluid channel of the stationary housing part, by means of the seal ring carrier, in order to ensure precise sealing between the adjoining sealing surfaces of the two seal rings. A stator seal ring which is axially displaceable in this way and is optionally slightly tiltable, is also referred to by experts as a floating (stator) seal ring.

In other words, in the case of a floating stator seal ring the mechanical seal comprises a seal ring assembly, which is axially movable, but non-rotating, in the stationary housing part, comprising the stator seal ring and a complementary rotor seal ring that rotates together with the rotor. The rotor seal ring can be fastened, e.g. pressed and/or adhesively bonded or otherwise fastened, for example at the end face of the rotor facing the stationary housing part.

However, it is not impossible to reverse the assembly consisting of the floating seal ring and the seal ring complementary thereto, i.e. to suspend the rotor seal ring in an axially movable manner, in order to form the rotor seal ring as a floating seal ring. In both cases, the mechanical seal can be formed having AutoSense® and Pop-Off® functionality.

The rear end of the seal ring carrier, remote from the mechanical seal, preferably opens into the working space or inner fluid channel, which in particular extends coaxially with the rotor, the mechanical seal and/or the seal ring carrier. The working space, the hollow seal ring carrier, and the rotor fluid channel together form an in particular straight central overall fluid channel of the rotary union, which extends axially through the stationary housing part and the rotor. The overall fluid channel is thus formed by a stationary channel portion and a rotating channel portion coaxial thereto, which are sealed against one another by means of the axial mechanical seal. The rotary union preferably comprises just one single central overall fluid channel, into which the media inlet channels open. Further preferably, the rotary union comprises just one single axial mechanical seal in the central overall fluid channel.

The stationary housing part comprises at least a first and second media inlet channel having a first and second connection port, respectively, for example for a pipe or tube connection, for introducing fluid media into the stationary housing part, wherein the first and the second media inlet channel open into the inner fluid channel of the stator. By means of the two separate media inlet channels, different fluid media can be introduced into the rotary union, alternatively either into one or into the other media inlet channel, selectively in succession, under pressurization.

The mechanical seal now has a first balance ratio upon pressurization of the first media inlet channel with medium, and a second balance ratio, different from the first balance ratio, upon pressurization of the second media inlet channel with medium. Accordingly, different media inlet channels are assigned different balance ratios. In particular, the second balance ratio is greater than the first balance ratio.

The rotary union can advantageously be operated using very different media, in particular compressible media (gases, compressed air, aerosols, reduced or minimum quantity lubrication (RQL/MQL)) on the one hand, and incompressible media on the other hand (liquids, such as cooling lubricant (CL), cutting oil and/or hydraulic oil). Therefore, the rotary union can be referred to as multimedia-compatible. It is particularly advantageous for the rotary union to also operate reliably with higher-viscosity media, such as cutting oil or hydraulic oil, in addition to low-viscosity liquid media such as CL. Furthermore, the present rotary union also has excellent dry running properties, i.e. operation without pressurized medium, also with low wear and high stability. Furthermore, the leakage rate in compressed-air operation can be kept at an acceptably low level. Therefore, the present rotary union can even be referred to as all media-compatible.

In particular, the axial mechanical seal provides substantially leak-free sealing under pressurization with a liquid medium, and, in compressed-air operation, the mechanical seal opens in a controlled manner, i.e. the opening results in a controlled air gap between the stator seal ring and the rotor seal ring, such that a controlled air leakage or an air cushion can be established between the seal rings, in compressed-air operation. By means of the balance ratio effective in each case, i.e. the different balance ratios at the various media inlet channels, on the one hand a relatively low predefined gas leakage upon pressurization with a gaseous medium at the first media inlet channel, and on the other hand substantial freedom from leaks upon pressurization with liquid medium at the second media inlet channel, can be set or optimized independently from one another in each case.

The rotary union can be operated using media having a low viscosity or incompressible media, via the first media inlet channel, having the first lower balance ratio, and alternatively using media having a higher viscosity, via the second media inlet channel, having the second higher balance ratio, and in this case can exhibit a satisfactory sealing effect as well as low wear, with all media. In other words, upon pressurization of the first media inlet channel or in the pressure-free state the mechanical seal has the first, in particular lower, balance ratio, and upon pressurization with in particular liquid medium of the second media inlet channel switches to the second, in particular higher, balance ratio.

The switching between the different balance ratios takes place automatically, in a hydraulic or pneumatic manner, by the selective pressurization either of the first or of the second media inlet channel, or depressurization.

The multimedia-compatible rotary union can be operated via the first media inlet channel, for example with a compressible medium, e.g. a gaseous medium, e.g. compressed air, and alternatively via the second media inlet channel, e.g. with a higher-viscosity liquid medium, e.g. cutting oil, e.g. having a viscosity in the range from 6 mm²/s to 18 mm²/s or e.g. with a hydraulic oil, e.g. having a viscosity in the range from 32 mm²/s to 46 mm²/s (40° C.), optionally even up to 60 mm²/s (40° C.) or more, in each case at high rotational speeds, e.g. 24,000 min⁻¹, without the seal rings excessively overheating, and with an acceptably low leakage rate or substantially leak-free. The first media inlet channel can, however, optionally also be operated with a low-viscosity liquid medium, e.g. cooling lubricant (CL), e.g. having a viscosity in the range from 1 mm²/s to 3 mm²/s. Preferably, the two different balance ratios are thus selected in such a way, or are set in such a way by means of the diameter ratios, that the first balance ratio is suitable for compressible media and/or liquid media having low viscosity, and the second balance ratio is suitable for liquid media having high viscosity.

The rotary union accordingly in particular comprises a hydraulically or pneumatically controlled balance ratio switching device, by means of which the mechanical seal or, more precisely, the axially movable (stator) seal ring assembly, can be switched hydraulically or pneumatically between the first and second balance ratio. The switching from the first to the second balance ratio, or vice versa, preferably takes place by pressurization or depressurization of the second media inlet channel. In other words, the lower first balance ratio is present when no media pressure is applied or when the first media inlet channel is pressurized, preferably with a medium having lower viscosity, and the rotary union switches to the higher second balance ratio when the second media inlet channel is pressurized, preferably with a liquid medium of higher viscosity.

Preferably, the axial sealing force is brought about substantially by the medium pressure (hydraulically/pneumatically). Such mechanical seals are also referred to as balanced mechanical seals. In other words, the mechanical seal is a balanced mechanical seal, in which the balance ratios are selected in such a way that the mechanical seal is balanced exclusively hydraulically or pneumatically. In the case of said mechanical seals, the axial sealing force is thus substantially set by the geometric balance ratio. Corresponding rotary unions having a balance ratio in a specific range are also provided, by the applicant, with the designation Autosense®. A mechanical seal of this kind can in particular operate without opening and/or without closing springs, wherein, however, certain spring elements, which generate additional, optionally small, opening or closing forces, should in principle not be excluded.

Thus, in an advantageous manner, a universal multimedia-compatible rotary union can be provided, which is suitable for pressurization with very different media, e.g. compressible media on the one hand, e.g. compressed air, and highly viscous liquid media, e.g. cutting oil or hydraulic oil, on the other hand, and specifically has high stability at high rotational speeds, and a leakage rate in the case of all the media used, in particular is substantially leak-free in the case of liquid media.

Thus, according to one embodiment, the switching between the first and second balance ratio takes place hydraulically at the second media inlet channel, in such a way that the mechanical seal, when there is no pressure at the second media inlet channel, has the first balance ratio, and upon pressurization of the second media inlet channel, in particular with a liquid medium, has the second balance ratio, wherein the mechanical seal also has the first balance ratio in particular in the case of no pressure at the second media inlet channel and pressurized introduction of a fluid medium into the first media inlet channel.

The seal ring carrier is preferably designed in the form of a hollow piston. The “floating” seal ring of the stator is preferably fastened on the rotor-side end face of the hollow piston, which is mounted in the stationary housing part so as to be axially movable, in order to seal in a sliding manner against the rotating rotor seal ring, with a variable contact pressure and variable clearance depending on the medium. The switching from the first to the second balance ratio takes place hydraulically by pressurization on the outside diameter of the hollow piston by means of the medium introduced via the second media inlet channel. For this purpose, the hollow piston in particular has a smaller first and a larger second outside diameter or effective diameter, which correspond to the different balance ratios. The seal ring carrier is thus formed, for example as a stepped piston, having at least two different effective diameters, wherein a continuous transition between the two effective diameters is also possible. This applies correspondingly for a floating rotor seal ring.

Preferably, the stationary housing part comprises an internal control channel which branches from the second media inlet channel and leads to the hollow piston, in order to apply a medium pressure to its outside diameter, in order to change the balance ratio or to switch from the first to the second balance ratio.

According to one embodiment, the first and second media inlet channels are separated by a valve, which is in particular integrated in the stationary housing part. In particular, the second media inlet channel comprises an integrated check valve, and the control channel branches off from the second media inlet channel before the check valve and leads to the outside diameter of the hollow piston. It is thus possible to prevent a residual pressure from remaining in the control channel after the medium is switched off, e.g. in that an upstream, machine-side valve moves into the neutral position and vents the media tank.

Preferably, at least one other media inlet channel, in particular the first media inlet channel, does not comprise a control channel which leads to the second outside diameter of the hollow piston, such that in the case of pressurization of the second media inlet channel and of the control channel a different, in particular greater, balance ratio is established compared with in the case of pressurization of a media inlet channel, in particular the first media inlet channel, without such a control channel.

Thus, preferably (the same) hydraulic pressure is intended to be applied to the hollow piston of the axially movable stator seal ring assembly, via the internal control channel, which branches off from the second media inlet channel in the stationary housing part and leads to the, in particular larger second effective diameter of the hollow piston, around the second effective diameter of the hollow piston, by means of a liquid medium that is introduced, pressurized, into the second media inlet channel, in order to bring about the switching from the first to the second balance ratio.

Accordingly, the hollow piston preferably comprises a first axial region having a first effective diameter or outside diameter, and a second axial region having a second effective diameter or outside diameter, e.g. in the form of a stepped piston, wherein the first effective diameter corresponds to the first balance ratio, and the second effective diameter corresponds to the second balance ratio which differs from the first balance ratio, and the control channel leads to the second axial region, and the second balance ratio is brought about in that the second effective diameter of the hollow piston is pressurized, via the control channel, with the, in particular liquid, medium.

According to further embodiments, the stationary housing part can comprise one or more further media inlet channels, e.g. a third media inlet channel, for introducing fluid media. The third media inlet channel also opens into the inner fluid channel, such that fluid media of different viscosities can be introduced into the rotary union, under pressurization, alternately either via the first, the second or the third media inlet channel, wherein the media can be compressible or incompressible, depending on the media inlet channel. Advantageously, at least one of the media inlet channels, in particular the third media inlet channel, extends axially and opens axially into the inner fluid channel. This is advantageous for reduced quantity lubrication or minimum quantity lubrication This is present in particular in the form of an aerosol, and an undesired demixing can advantageously be prevented by channel guidance which is as straight as possible. It is clear that also even in the case of two media inlet channels one of the two can extend axially, in particular the first media inlet channel which has the lower balance ratio.

Preferably, the first, second and/or third media inlet channel open to the rear of the seal ring carrier, into the working space.

Preferably, even in the case of pressurization of the third media inlet channel with medium, in particular with an aerosol of a reduced or minimum quantity lubrication, the control channel is not pressurized, such that in the case of pressurization of the third media inlet channel the, in particular lower, first balance ratio is present.

Accordingly, one, a plurality of, or all of the following features can be fulfilled:
at least one of the media inlet channels extends radially and opens radially into the axial inner fluid channel, e.g. the first or second media inlet channel,
at least two of the media inlet channels extend radially and open radially into the axial inner fluid channel, e.g. the first or second media inlet channel,
one of the media inlet channels extends axially and opens axially into the axial inner fluid channel, e.g. the first or third media inlet channel.

Furthermore, one, a plurality of, or all of the following features can be fulfilled:
at least one of the media inlet channels comprises an integrated check valve, e.g. the first or second media inlet channel,
at least one of the radial media inlet channels comprises an integrated check valve, e.g. the first or second media inlet channel,
at least two of the radial media inlet channels in each case comprise an integrated check valve, e.g. the first and second media inlet channel,
the axial media inlet channel, e.g. the first or third media inlet channel, does not comprise an integrated (check) valve. Without a check valve in the axial media inlet channel, an undesired demixing of the aerosol can advantageously be prevented, in the case of reduced or minimum quantity lubrication.

Furthermore, at least one, a plurality of, or all of the following features can be fulfilled:
at least one of the media inlet channels, preferably the second media inlet channel, is arranged so as to bring about the, in particular greater, second balance ratio of the mechanical seal upon pressurization with higher-viscosity cutting or hydraulic oil, wherein the second balance ratio is suitable for cutting or hydraulic oil,
at least one other of the media inlet channels is arranged so as to bring about the first balance ratio of the mechanical seal upon pressurization, wherein the, in particular lower, first balance ratio is suitable for gaseous media, e.g. compressed air,
at least one of the media inlet channels is arranged so as to bring about the first or the second balance ratio upon pressurization with cooling lubricant (CL), wherein the first or second balance ratio is suitable for cooling lubricant (CL),
one of the media inlet channels, preferably the axial media inlet channel, is arranged so as to bring about the first balance ratio of the mechanical seal upon pressurization with an aerosol of a reduced or minimum quantity lubrication, wherein the first balance ratio is suitable for the aerosol of a reduced or minimum quantity lubrication.

Preferably, the first balance ratio of the mechanical seal (no pressure or upon pressurization of the first media inlet channel) has a value in the range from approximately 0.45 to 0.6, preferably in the range from 0.47 to 0.57, preferably in the range from 0.49 to 0.55, preferably a value of 0.52+/−0.02.

More preferably, the second balance ratio of the mechanical seal (upon pressurization of the second media inlet channel) has a value of greater than 0.6, preferably in the range from 0.62 to 1, preferably in the range from 0.65 to 0.7, preferably a value of 0.66+/−0.02.

Preferably, in the case of pressurization of the first media inlet channel with a fluid medium, in particular with a gaseous medium, e.g. compressed air, the first balance ratio is present, in the case of pressurization of the second media inlet channel with a liquid medium, in particular with cutting or hydraulic oil, the second balance ratio is present, and/or in the case of pressurization of the third axial media inlet channel with a fluid medium, in particular with an aerosol of a reduced or minimum quantity lubrication, the first balance ratio is present. Thus, in an advantageous manner a particularly universal rotary union can be created, which is suitable for almost all important different media, and which allows long-lasting reliable operation at high rotational speeds and low leakage rates for each of the media, or is substantially leak-free in the case of liquid media.

Preferably, the second media inlet channel extends radially and opens radially into the inner fluid channel, and another of the media inlet channels, e.g. the first or third media inlet channel, extends axially and opens axially into the inner fluid channel. Preferably, the balance ratio in the case of pressurization of the radial second media inlet channel and the balance ratio in the case of pressurization of the axial media inlet channel are different. In particular, the balance ratio in the case of pressurization of the radial second media inlet channel is greater than the balance ratio in the case of pressurization of the axial media inlet channel.

In an advantageous manner, for the present rotary union silicon carbide seal rings can be used for at least one of the seal rings, preferably for both the seal rings (SiC—SiC mechanical seal), wherein these can be used in the case of wide allowable operating parameters, such as rotational speed, media, viscosity, media pressure, temperature, etc. at a high degree of stability.

According to one embodiment, the control channel leads to an outside diameter of the hollow piston, and the hollow piston is sealed in the stationary housing part by means of a secondary seal. Preferably, the secondary seal comprises a first and a second secondary sealing ring, which are arranged on axially opposing sides of the control channel. In particular, the first secondary sealing ring is designed as an elastomer quad ring, and/or the second secondary sealing ring is designed as an elastomer ring having a U-shaped cross section, known as a U-cup ring. In particular, the connection of a quad ring to the side of the control channel facing the rotor has been found to be advantageous, in order, for example upon depressurization, to separate the two seal rings from one another, at least assisted by the resilient restoring force, generated by deformation of the quad ring, on the axially movably mounted seal ring assembly, in order for example to prevent undesired friction between the seal rings during pressure-free dry running. However, the elastomer U-cup ring can also contribute to the axial movement. Furthermore, in an advantageous manner short switching times can be achieved by means of the mentioned secondary seal.

It is noted that these advantages of the quad ring are not limited to the multimedia-compatible rotary union described above, but rather the quad ring can also be used in many conventional rotary unions, in particular having just one balance ratio and/or having just one media inlet channel.

Preferably, the quad ring is biased or preloaded on an outside diameter of the axially movable seal ring carrier or hollow piston, and/or is axially displaceable, relative to the stationary housing part, at its outside diameter. As a result, during opening and closing of the axial mechanical seal the quad ring can move axially relatively easily, together with the stator seal ring assembly, in the stationary housing part, and exert an axial force on the stator seal ring assembly. This can be advantageous with regard to the hydraulic forces acting on the quad ring and with regard to the axial movement of the stator seal ring assembly between the different media switching states. Preferably, the quad ring is accommodated in the stationary housing part in a peripheral groove having an axial oversize. As a result, the quad ring has axial clearance in the groove and can move axially in the groove. In the pressurized state, the medium pressure acts axially on the quad ring, in the direction of the rotor. As a result, the quad ring is pressed onto the rotor-side radial annular wall of the groove, when medium pressure is applied to the quad ring, which can lead to a deformation of the quad ring. When the quad ring is relieved of the medium pressure, e.g. upon depressurization, the stator seal ring assembly moves away from the rotor, wherein the sealing surfaces of the two seal rings can be released from one another, and a gap between the sealing surfaces can result. The quad ring subsequently preferably loses contact with the rotor-side radial annular wall. This can be advantageous for the axial movement of the stator seal ring assembly when the rotary union is subjected to medium pressure or relieved of medium pressure, and can contribute to reliable and quick closing and opening of the axial mechanical seal, i.e. contacting and detaching of the axial sealing surfaces of the two seal rings.

The present disclosure furthermore relates to a multimedia-compatible or all media-compatible rotary union for transferring different fluid media, having different viscosities, from a stationary machine part to a rotating machine part, comprising:
a stationary housing part for installation in the stationary machine part, and comprising a working space or inner axial or central fluid channel,
a rotor, in the form of a hollow shaft, for connection to the rotating machine part and to an axial or central fluid channel for establishing a fluidic connection to the working space or inner fluid channel of the stationary housing part,
an axial mechanical seal between the stationary housing part and the rotor, for sealing the fluidic connection of the stationary housing part relative to the rotating rotor, wherein the mechanical seal comprises a rotor seal ring, rotating together with the rotor, on the end face facing the stationary housing part, and an axially movable, non-rotating stator seal ring assembly having a (“floating”) stator seal ring, in the stationary housing part, or vice versa,
wherein the stationary housing part comprises at least a first and second media inlet channel comprising a first and second connection port for introducing fluid media into the stationary housing part, wherein the first and second media inlet channels open into the inner fluid channel, and wherein different fluid media of different viscosities can be introduced, optionally alternately, into the rotary union, under pressurization, via the first or the second media inlet channel, in particular compressible media in one media inlet channel and higher-viscosity incompressible media, such as cutting oil or hydraulic oil, in the other media inlet channel, and
wherein a hydraulically or pneumatically controlled balance ratio switching device is included, by means of which the axially movable (stator) seal ring assembly is switched, by means of the respective medium pressure (hydraulically or pneumatically) between a first and second balance ratio.

According to a further aspect of the present disclosure, a rotary union for transferring fluid media from a stationary machine part to a rotating machine part is provided, which rotary union comprises a stationary housing part for installation in the stationary machine part, and a rotor for connection to the rotating machine part. The rotary union further comprises a working space or inner axial or central fluid channel in the stationary housing part, and an axial or central fluid channel in the rotor, for establishing a fluidic connection to the working space or inner fluid channel of the stationary housing part. The rotor is in particular designed in the form of a hollow shaft.

The rotary union further comprises an axial mechanical seal between the stationary housing part and the rotor, for sealing the fluidic connection of the stationary housing part relative to the rotating rotor, wherein the mechanical seal comprises a rotor seal ring, rotating together with the rotor, on the end face of the rotor facing the stationary housing part, and a stator seal ring. As already described above, either the stator seal ring or the rotor seal ring can be fastened to an axially movably mounted seal ring carrier and can thus be designed as an axially movable (floating) seal ring.

According to this aspect of the present disclosure, the stationary housing part comprises at least one media inlet channel having a connection port for introducing fluid, e.g. compressible, incompressible, in particular liquid, gaseous or aerosol media, into the stationary housing part, wherein the media inlet channel opens into the working space or inner fluid channel.

The rotary union furthermore preferably comprises a resilient shape-recovery element which, upon pressurization with liquid medium, is pressed axially against a transversely extending wall of the stationary housing part by the medium pressure, and in the process is deformed elastically. In the case of relief of pressure or depressurization, the resilient shape-recovery element recovers its shape and pushes away from the transversally extending wall again, by the resilient shape recovery, and in the process pulls the seal ring assembly away from the rotor, in order to open the mechanical seal. The wall accordingly forms an axial stop for the resilient shape-recovery element. The resilient shape-recovery element consists in particular of elastomer material or is formed as an elastomer ring. The elastomer ring is preferably formed as an O-ring having an approximately rectangular or square cross section, preferably having rounded corners, wherein the rounded corners form lip seals.

Preferably, a secondary seal is included, by means of which the seal ring carrier is axially displaceably mounted and sealed, e.g. in the stationary housing part. According to this aspect of the present disclosure, the elastomer shape-recovery element preferably forms a secondary sealing ring of the secondary seal of the axially movable seal ring assembly consisting of the seal ring carrier and associated seal ring. The elastomer shape-recovery element or the first secondary sealing ring is preferably designed as an elastomer quad ring, sometimes also referred to as an X-ring. The secondary seal accordingly allows for axial displacement of the stator seal ring assembly, in order to close and open the mechanical seal, i.e. to bring the axial sealing surfaces of the two seal rings into contact and to separate them again, such that, in particular for reliable dry running without pressure, an air gap results between the sealing surfaces.

The secondary seal preferably comprises a second secondary sealing ring.

A control channel preferably extends in the stationary housing part, which control channel opens at an outside diameter of the axially movable stator seal ring assembly, in order to apply pressure to the axially movable stator seal ring assembly, at its outside diameter, by means of fluid medium, in particular in order to change the balance ratio. The first and second secondary sealing ring are preferably arranged on axially opposing sides of the control channel, in order to mount the stator seal ring assembly in an axially displaceable manner at two points that are axially spaced from one another, and to axially seal the control channel on both sides.

The second secondary sealing ring can preferably be designed as an elastomer ring, in particular having a U-shaped cross section, known as a U-cup ring.

According to one embodiment, the elastomer shape-recovery element or the quad ring, and the second secondary sealing ring (the elastomer ring having a U-shaped cross section), have different inside diameters and seal the axially movable seal ring carrier at points having a different outside diameter.

In particular, the elastomer shape-recovery element or the quad ring is arranged between the control channel and the “floating” stator seal ring, and seals the control channel on the rotor side.

Preferably, the elastomer shape-recovery element or the quad ring is preloaded on the outside diameter of the axially movable seal ring carrier. This has been found to be advantageous with regard to the mobility of the stator seal ring assembly and the reliability of the opening of the mechanical seal at the transition to dry running.

The elastomer shape-recovery element or the quad ring being axially displaceable, at its outside diameter, relative to the stationary housing part can also advantageously contribute to this.

Preferably, the stationary housing part comprises a peripheral groove, produced having an axial oversize, for the elastomer shape-recovery element or the quad ring, in which groove the elastomer shape-recovery element or the quad ring is accommodated. The elastomer shape-recovery element or the quad ring has axial clearance in the groove, such that it can move axially relative to the groove, which can also have a positive influence on the axial movement of the stator seal ring assembly. Due to the preload of the elastomer shape-recovery element or quad ring on the seal ring carrier, the elastomer shape-recovery element or the quad ring, and the seal ring carrier, move axially together, as a unit, within the axial oversize of the groove.

The peripheral groove preferably has a radially outer peripheral groove base, and the elastomer shape-recovery element or the quad ring is axially displaceable relative to the groove base.

According to one embodiment, the seal ring carrier of the axially movable stator seal ring assembly is designed as a hollow piston, which is axially movably mounted in the stationary housing part by means of the secondary seal, and the (“floating”) stator seal ring is fastened, for example adhesively bonded, shrunk, pressed or screwed, onto the rotor-side end face of the hollow piston. The elastomer shape-recovery element or the quad ring is preferably preloaded on the outside diameter of the hollow piston, with slight pre-pressing.

Preferably, the hollow piston has two axial regions of different effective diameters or outside diameters, and the medium acts on the larger of the two effective diameters, with medium pressure, via the control channel. Furthermore, the control channel preferably comprises a control channel groove that surrounds the hollow piston, in order to peripherally apply medium pressure to the hollow piston. The peripheral control channel groove is fluidically connected to the groove of the elastomer shape-recovery element or quad ring, such that in the case of pressurization of the control channel with in particular liquid medium, the medium pressure acts on the elastomer shape-recovery element or the quad ring, on the axial end face thereof facing away from the rotor, such that the medium pressure brings about an axial force on the axial end face of the elastomer shape-recovery element or quad ring facing away from the rotor, in the direction of the rotor. By means of said axial force brought about by the medium pressure, the elastomer shape-recovery element or the quad ring can be pressed against the rotor-side annular wall of the groove. In this case, the elastomer shape-recovery element or the quad ring, in particular the curved axial end face of the elastomer shape-recovery element or quad ring facing away from the rotor, can deform axially and, when the medium pressure ceases, the restoring force can contribute to axial movement away from the rotor, in order to open the mechanical seal again.

It can be advantageous if at least the axial end face facing away from the rotor and/or the axial end face of the elastomer shape-recovery element facing the rotor are concavely shaped in the relaxed state. As a result, the medium pressure can act successfully on the elastomer shape-recovery element, and the elastomer shape-recovery element deforms in a suitable manner, at the rotor-side radial annular wall of the groove.

Preferably, under pressurization with medium, the axial end face of the elastomer shape-recovery element facing the rotor rests in an annular manner on a rotor-side wall of the stationary housing part, at least by two sealing lips, and/or upon pressure relief the elastomer shape-recovery element pushes away from the rotor-side wall of the stationary housing part again, by elastic shape recovery of the at least two sealing lips.

Preferably, the inner periphery of the elastomer shape-recovery element is concavely shaped, such that the elastomer shape-recovery element rests annularly on the hollow piston in a preloaded manner at at least two axial points, in the manner of a double lip seal, when the elastomer shape-recovery element is preloaded on the outer periphery of the hollow piston. Expediently, the elastomer shape-recovery element has a four-sided concave shape in cross section and/or has rounded corners. As a result, good adhesion between the elastomer shape-recovery element and the hollow piston can be achieved, and a reliable Pop-Off® function can be ensured.

Thus, in summary, under pressurization with an in particular liquid medium, the axially movable stator seal ring assembly comprising the (“floating”) stator seal ring can be pressed against the rotor seal ring, in order to provide a mechanical seal having the required tightness, in particular for liquid media, and the elastomer shape-recovery element or the quad ring undergoes elastic deformation of its annular cross section in the process. Under depressurization, the restoring force brought about by the elastic deformation of the annular cross section at least contributes to the axially movable stator seal ring assembly, comprising the stator seal ring, detaching from the rotor seal ring, such that an air gap can result between the stator seal ring and the rotor seal ring, e.g. in order to allow frictionless dry running of the rotary union. As a result, the Pop-Off® property of the mechanical seal can be improved.

The material of the elastomer shape-recovery element or of the elastomer quad ring preferably contains a fluroroelastomer, e.g. Viton®.

In other words, the rotary union comprises a quad ring, in particular as the secondary sealing ring of the secondary seal, by means of which the seal ring assembly is axially movably mounted and sealed in the stationary housing part. In the case of pressurization with liquid medium, the quad ring is pressed axially against a rotor-side wall of the stationary housing part by the medium pressure, and deforms elastically in the process. Upon pressure relief, the quad ring recovers its shape and pushes away from the wall due to the resilient shape recovery. In the process, the quad ring, which is recovering its shape, pulls the seal ring assembly away from the rotor, wherein the mechanical seal opens.

These and other aspects are merely illustrative of the innumerable aspects associated with the present disclosure and should not be deemed as limiting in any manner. These and other aspects, features, and advantages of the present disclosure will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the present disclosure and wherein similar reference characters indicate the same parts throughout the views.

FIG. 1 is a longitudinal section through a rotary union according to one embodiment of the present disclosure, having a closed mechanical seal,

FIG. 2 is a detailed enlargement of the detail A in FIG. 1,

FIG. 3 is a longitudinal section through the rotary union from FIG. 1 having an open mechanical seal,

FIG. 4 is a detailed enlargement of the detail B from FIG. 3,

FIG. 5 is a cross section along the line 5-5 in FIG. 3,

FIG. 6 is a cross section along the line 6-6 in FIG. 3,

FIG. 7 is a cross section along the line 7-7 in FIG. 3,

FIG. 8 is a front view of the rotary union from FIG. 1-4, viewed from the spindle side,

FIG. 9 is an axial front view of the rotary union from FIG. 1-4, viewed from the stationary housing side,

FIG. 10 is a three-dimensional view of the rotary union from FIG. 1-4, viewed obliquely from the front,

FIG. 11 is a three-dimensional view of the rotary union from FIG. 1-4, viewed obliquely from behind,

FIG. 12 is a longitudinal section through the rotary union from FIG. 1-11, flange-mounted on a spindle and with a fluid circuit diagram for the pressurization with fluid media,

FIG. 13 is a three-dimensional view of a rotary union according to a further embodiment of the present disclosure, viewed obliquely from the front,

FIG. 14 is a three-dimensional view of the rotary union from FIG. 13, viewed obliquely from behind,

FIG. 15 is a longitudinal section through the rotary union from FIGS. 13 to 14 comprising a lance for reduced or minimum quantity lubrication,

FIG. 16 is a front view of the rotary union from FIG. 15, viewed from the stationary housing side,

FIG. 17 is a longitudinal section through a rotary union of one embodiment of the present disclosure, having a closed mechanical seal, under pressurization with liquid medium,

FIG. 18 is a detailed enlargement of the detail C in FIG. 17,

FIG. 19 is a further enlarged detail D from FIG. 18,

FIG. 20 as FIG. 18, but under depressurization and having an open mechanical seal,

FIG. 21 is a further enlarged detail E from FIG. 20,

FIG. 22 is a schematic view of a detailed longitudinal section of a seal ring assembly for explaining the balance ratio in axial mechanical seals.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

In the following detailed description numerous specific details are set forth in order to provide a thorough understanding of the present disclosure. However, it will be understood by those skilled in the art that the present disclosure may be practiced without these specific details. For example, the present disclosure is not limited in scope to the particular type of industry application depicted in the figures. In other instances, well-known methods, procedures, and components have not been described in detail so as not to obscure the present disclosure.

The headings and sub-headings used herein are intended only for general organization of topics within the present disclosure and are not intended to limit the disclosure of the technology or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Detailed Description” section of this specification are hereby incorporated by reference in their entirety.

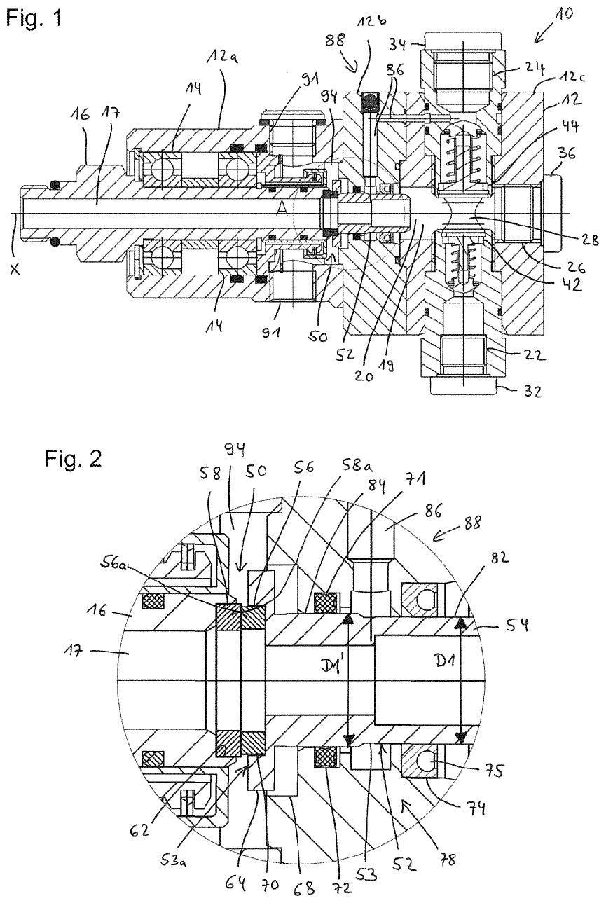

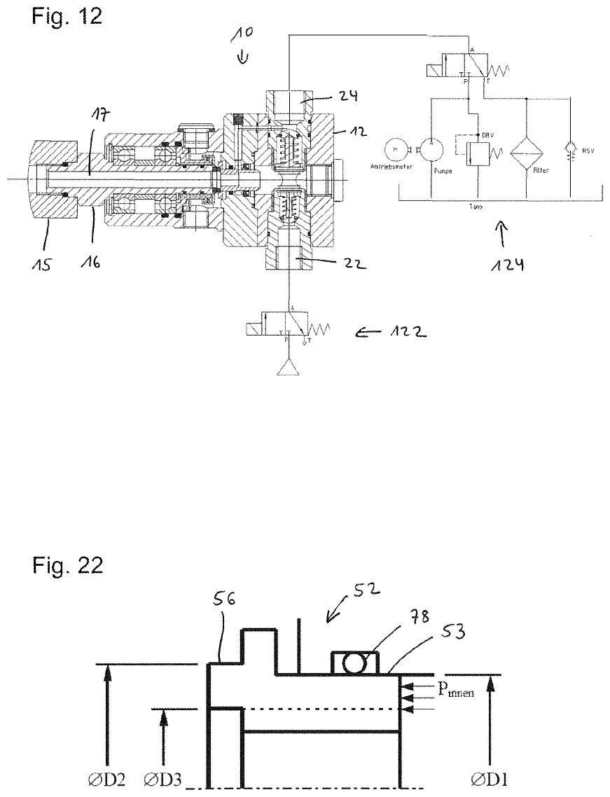

With reference to FIG. 1-4, the feedthrough or rotary union 10 comprises a stationary housing part 12 at the rear, which is formed in multiple parts in the present example. A rotor 16 for connection to a machine spindle 15 (cf. FIG. 12), in this example in the form of a hollows haft, is mounted in the housing part 12 in a rotating manner by means of rolling bearings, e.g. ball bearings 14. In this example, the rotary union 10 comprises first and second radial media inlet channels 22, 24 having different properties, and a third axial media inlet channel 26. Each of the media inlet channels 22, 24, 26 in each case has a connection port 32, 34, 36, e.g. having a quick coupling for connection to suitable tube or pipe systems, in order to introduce the desired fluid media into the stationary housing part 12 of the rotary union 10, under pressurization. In this case, the media inlet channels 22, 24, 26 are preferably pressurized by medium alternately, and not simultaneously. The two radial media inlet channels 22, 24 each comprise a check valve 42, 44, in order to block said channels with respect to one another and with respect to pressurization of the third media inlet channel 26.

Both the two radial media inlet channels 22, 24, and the axial media inlet channel 26, open, at a fluid connection node 28, into a working space 19 in the stationary housing part 12. In this example, the working space 19 comprises an inner fluid channel 20, coaxial to the axis of rotation X, such that different fluid media can be introduced, in a pressurized manner, into the inner fluid channel 20 of the stationary housing part 12, alternately or selectively via each of the three connection ports 32, 34, 36 or media inlet channels 22, 24, 26.

The axial media inlet channel 26 is suitable in particular for a reduced or minimum quantity lubrication. Said media inlet channel 26 extends exclusively axially, without significant changes of direction for the fluid medium, as a result of which an undesired demixing of the aerosol used for the reduced or minimum quantity lubrication can be largely prevented. Furthermore, no branches are present in the axial media supply line, and no check valves are used, which also contributes to preventing undesired demixing of the aerosol. However, the axial media inlet channel may for example also be suitable for compressed-air operation or optionally also for cooling lubricant (CL).

The two radial media inlet channels 22, 24 each comprise an integrated check valve 42, 44, such that the user does not have to provide any further external check valves in these media supply lines. The radial first media inlet channel 22 can in particular be designed for compressed-air operation, but can also be suitable for pressurization using cooling lubricant (CL). The radial second media inlet channel 24 is designed in particular for pressurization using a high-viscosity medium, such as cutting oil or hydraulic oil, but can also be suitable for a lower viscosity liquid medium, such as cooling lubricant (CL).

The stationary housing part 12 and the rotor 16 are sealed by means of an axial mechanical seal 50. The mechanical seal 50 comprises a seal ring assembly 52 comprising an axially displaceable seal ring carrier 53 and a seal ring 56 fastened to the seal ring carrier 53. The seal ring 56 of the stator, or stator seal ring 56 for short, seals, with its rotor-side axial annular sealing surface 56a, against a rear axial annular sealing surface 58a of the complementary seal ring 58 of the rotor 16. The seal ring 58 of the rotor 16, or rotor seal ring 58 for short, is fastened on the stator-side end face 16a of the rotor 16, in this example pressed and/or adhesively bonded into an annular groove 62.

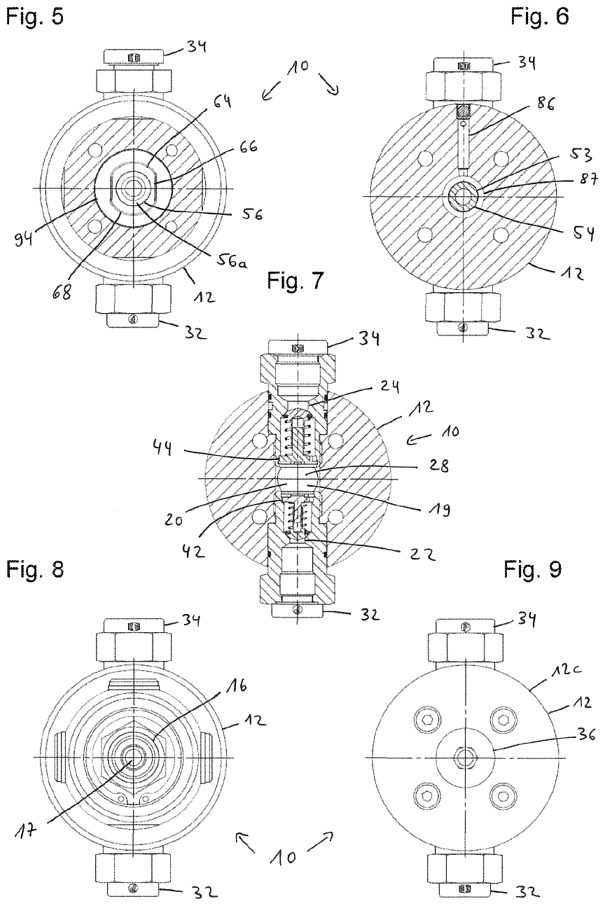

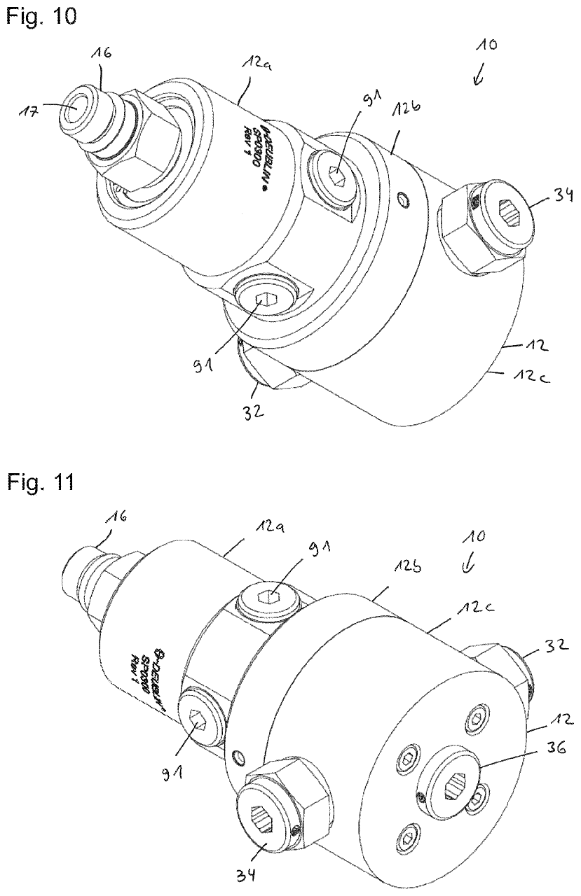

The seal ring carrier 53 of the stator seal ring 56 is designed for example as a hollow piston 54, and in this example comprises a rotor-side flange 64 which is arranged in a torsion-proof, but axially movable, manner in the stationary housing part 12 for example by means of flat portions 66 (cf. FIG. 5), e.g. is accommodated in the stationary housing part 12 in a torsion-proof manner, in a corresponding rotor-side recess 68. However, the seal ring assembly 52 or the hollow piston 54 can also be secured against rotation by means of pins, grooves, or other means. The stator seal ring 56 is fastened, e.g. pressed in or adhesively bonded, at the end face on the rotor-side end 53a of the seal ring carrier 53 or hollow piston 54, wherein other fastening techniques are also possible, however. In the present example, the stator seal ring 56 is, by way of example, permanently fastened in a recess 70 of the seal ring carrier 53, more precisely of the flange 64.

The seal rings 56, 58 preferably both consist of silicon carbide, such that reference is often made to a SiC—SiC mechanical seal 50. A SiC—SiC mechanical seal 50 is durable and has excellent sealing properties during operation with liquid, highly lubricating media. However, some conventional rotary unions have stability problems in the case of operation with compressed air or in dry running with silicon carbide seals. SiC seal rings can for example overheat, if they run without lubricant and are not sufficiently separated from one another, which can lead even to complete failure of the rotary union. However, other materials can also be considered for the seal rings 56, 58, such as carbon graphite (CG), i.e. for example a CG-SiC mechanical seal.

Referring again to FIG. 1-4, the seal ring assembly 52 of the stator, or stator seal ring assembly 52 for short, or the hollow piston 54, is mounted in the stationary housing part 12 so as to be axially displaceable, specifically by means of a secondary seal 78. In this example, the secondary seal 78 comprises first and second secondary sealing rings 72, 74 in the form of two elastomer annular seals. In this example, the rotor-side first elastomer annular seal 72 is formed as an elastomer quad ring 72, for example from a fluorelastomer, such as Viton®. In the present example, the stator-side or rear elastomer second annular seal 74 has a U-shaped cross section having a groove 75 which is open to the rear or at the high-pressure side.

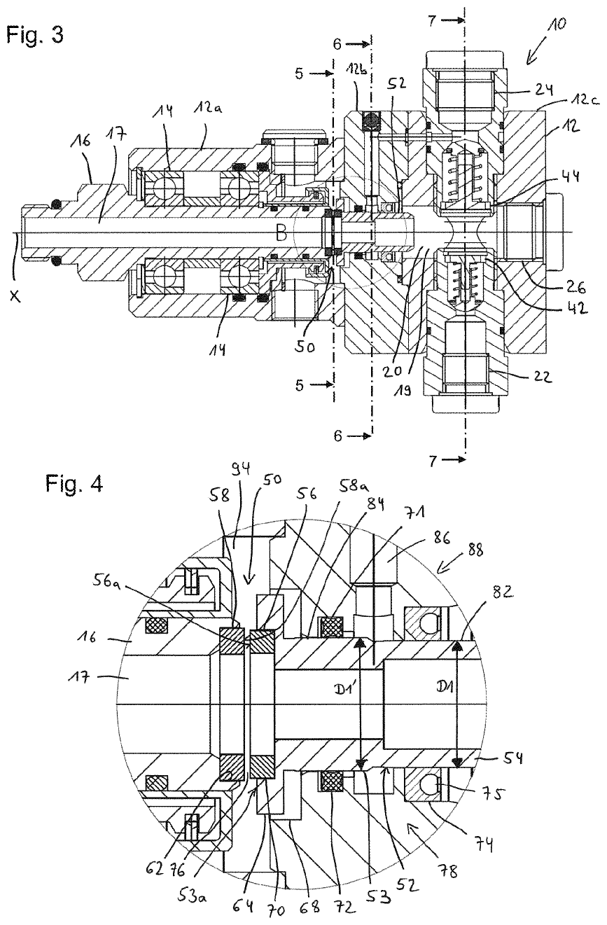

The mounting of the hollow piston 54 by means of the two elastomer annular seals 72, 74 allows the stator seal ring assembly 52 or the stator seal ring 56 a limited axial mobility, in order to be able to close (FIG. 1, 2) the mechanical seal 50 and open it again (FIG. 3, 4). Typically, during operation with pressurized fluid media having liquid lubricant fractions, such as CL, cutting oil or hydraulic oil, the mechanical seal 50 is closed, such that at most a minimal optionally dropwise, leakage (bleeding) occurs. When the mechanical seal 50 is closed, such media ensure sufficient lubrication between the two silicon carbide sliding surfaces 56a, 58a. In dry running or in compressed-air operation, in the closed state, the two silicon carbide seal rings 56, 58 could rub against one another and heat up excessively. Therefore, the mechanical seal 50 opens upon depressurization or in compressed-air operation, in that the hollow piston 54 together with the stator seal ring 56, i.e. the stator seal ring assembly 52, detaches from the rotor seal ring 58 and moves slightly axially away from this in the axial direction, i.e. to the right in the present figures, such that a sealing gap 76 results between the seal rings 56, 58 (cf. FIG. 4, 20).

The two elastomer annular seals 72, 74 together form the secondary seal 78 of the stationary part of the rotary union 10. The elastomer secondary seal 78 thus fulfils a dual function for the stator seal ring assembly 52, specifically as an axially displaceable bearing on the one hand, and as a seal against the pressurization with fluid medium from the stationary side on the other hand.

On account of the mounting by means of the elastomer sealing rings 72, 74, the stator seal ring assembly 52 may also have a slight tilting capacity, such that the sealing surfaces 56a, 58a of the two seal rings 56, 58 rest completely flat against one another in the pressurized state, and can achieve correspondingly good sealing. A stator seal ring 56 of this kind which is axially displaceable and is optionally slightly tiltable is also referred to by experts as a floating seal ring.

With reference to FIGS. 3 and 4, in the open state of the mechanical seal 52 there is a sealing gap 76 between the seal rings 56, 58, wherein the sealing gap 76 may be shown exaggerated in FIGS. 3 and 4 for better illustration. Thus, in the open state of the mechanical seal 50, although e.g. in compressed-air operation a certain air leakage rate results, which, in the present embodiments, can be approximately 15-20 standard liters per minute, this is, however, significantly lower than in the case of some conventional rotary unions. Furthermore, the present rotary union 10 has excellent dry running properties, since in dry running excessive heating of the seal rings 56, 58 can be prevented. The rotary union can therefore be operated in a largely unlimited manner with high rotational speeds, without pressure during dry running, but also with compressed air.

With reference to FIG. 22, the balance ratio B of a floating seal ring is defined by the area ratio FH/F of the hydraulically or pneumatically loaded surface FH to the contact surface F between the two seal rings 56, 58. Thus, the balance ratio B can be calculated geometrically, on the basis of the diameters D1, D2 and D3, as follows:

$$B = \frac{{F}_{H}}{F} = \frac{D {1}^{2} - D {3}^{2}}{D {2}^{2} - D {3}^{2}}$$

wherein D1 is the outside diameter or effective diameter of the pressurized seal ring carrier, D2 is the outside diameter of the contact surface of the mechanical seal, and D3 is the inside diameter of the contact surface of the mechanical seal.

With reference again to FIGS. 1 to 4, the hollow piston 54 is designed as a stepped piston, and thus comprises a stator-side first axial region 82 having a first outside diameter D1, and a rotor-side second axial region 84 having a larger second outside diameter D1′ (D1′>D1).

A control channel 86 is connected internally, and branches off from the second media inlet channel 24, in the stationary housing part 12. In particular, the control channel 86 branches off from the radial second media inlet channel 24 in front of the check valve 44 or at the high-pressure side of the check valve 44. The control channel 86 is thus integrated in the stationary housing part 12, e.g. in the form of (a) drilled hole(s), and branches off from the media inlet channel 24 within the rotary union 10. As a result, the internal control channel 86 is reliably depressurized as soon as the in particular liquid medium is switched off at the second media inlet channel 24.

The control channel 86 extends within the stationary housing part 12, in the present example initially axially in the direction of the rotor side, and subsequently radially inwards in the direction of the hollow piston 54. Finally, the control channel 86 opens on the peripheral outer side of the hollow piston 54 and is arranged such that the larger second outside diameter D1′ of the hollow piston 54 is also pressurized with the medium introduced into the second media inlet channel 24, via the control channel 86. For this purpose, there is a fluidic connection between the control channel 86 and the second axial region 84 with the outside diameter D1′ of the hollow piston 54. A pressurized introduction of fluid medium, via the connection port 34, into the media inlet channel 24 therefore leads not only to pressurized introduction of the fluid medium into the inner fluid channel 20 and the rotor fluid channel 17, but rather, automatically, in a pressurized manner, also the second axial region 84 with the outside diameter D1′ of the hollow piston 54. Thus, in relation to the balance ratio, the larger outside diameter or effective diameter D1′ of the hollow piston 54 is activated. Thus, the seal ring carrier 53 or the stepped piston 54, together with the control channel 86, forms a hydraulically or pneumatically controlled switching device 88 for the balance ratio of the mechanical seal 50

If the first media inlet channel 22 or the axial media inlet channel 26 is pressurized with fluid medium, the mechanical seal 50 accordingly has the smaller balance ratio B, which is determined by the smaller outside diameter D1 in the first axial region 82 of the hollow piston 54. If, instead, the media inlet channel 24 is pressurized with fluid medium, this activates, via the control channel 86, the larger outside diameter D1′ in the rotor-side second axial region 84 of the hollow piston 54, such that a second, different, and specifically in the present example greater, balance ratio B′ is established, which is calculated as follows:

$${B}^{′} = \frac{{F}_{H}^{′}}{F} = \frac{D {1}^{′2} - D {3}^{2}}{D {2}^{2} - D {3}^{2}} > B$$

Depending on whether one of the media inlet channels 22, 26 without a control channel, or the media inlet channel 24 comprising the control channel 86, is pressurized with the fluid medium, the mechanical seal accordingly has a different balance ratio, specifically once B and once B′. In other words, each media inlet channel is assigned a specific balance ratio, or different media inlet channels are assigned different balance ratios. Accordingly, the balance ratio of the mechanical seal can be selected, and hydraulically or pneumatically set automatically, or the mechanical seal 50 can be switched between the different balance ratios B and B′, by the selection of the corresponding port or media inlet channel.

In this case, the first balance ratio B which is assigned to the media inlet channels 22, 26 is selected for fluid media of lower viscosity, and in particular suitable for compressed air, reduced or minimum quantity lubrication, and optionally cooling lubricant (CL), and, in the present example, is approximately 0.52+/−0.02. The leakage rate for compressed air can furthermore be kept low as a result. However, the first balance ratio B can also be slightly broader in the range from 0.45 to 0.6, preferably in the range from 0.47 to 0.57, preferably in the range from 0.49 to 0.55.

The greater second balance ratio B′, which is assigned to the second media inlet channel 24 and is automatically present in the case of pressurization of the second media inlet channel 24 via the second connection port 34, is defined by the larger outside diameter D1′ and, in the present example, is approximately 0.66+/−0.02. In this case, the second balance ratio B′ is selected for fluid media of a higher viscosity, such as cutting oil having viscosities of from approximately 6 mm²/s to 18 mm²/s or higher and hydraulic oil having viscosities in the region of 32 mm²/s or higher, but can also be suitable for cooling lubricant having viscosities in the range from 1 mm²/s to 3 mm²/s. Thus, the media inlet channels 22 and 26 fixedly associated with the first balance ratio are suitable for compressible media, in particular gaseous media such as compressed air, and aerosol media such as reduced or minimum quantity lubrication, as well as lower viscosity liquid media, such as cooling lubricant up to a few mm²/s, whereas the second media inlet channel 24 having the fixedly associated second balance ratio B′ is particularly suitable for liquid media having viscosities from a few mm²/s to 60 mm²/s or more. However, the second balance ratio B′ can also be slightly broader, specifically greater than 0.6, preferably in the range from 0.62 to 1, preferably in the range from 0.65 to 0.7.

As has already been stated above, there is in each case a fixed association between specific media inlet channels 22, 24, 26 and specific balance ratios B, B′, which significantly simplifies connection by the user. The user for example connects compressed air at the first connection port 32, hydraulic oil or CL at the second connection port 34, and/or reduced or minimum quantity lubrication at the axial third connection port 36, and can largely omit an external pipe distributor or manifold comprising external check valves and further valves, as can be seen for example in FIG. 12, where, by way of example, the first media inlet channel 22 is connected to a cooling lubricant supply unit 122, and the second media inlet channel 24 is connected to a hydraulic oil supply unit 124. In particular the local separation of different fluid media by means of different media inlet channels, in combination with a fixed association of the different balance ratios B, B′ with the corresponding media inlet channels, can simplify connection by the user. Inter alia, the user does not need to interconnect any external control lines comprising different media.

Furthermore, the rotary union 10 has different balance ratios for different fluid media, such that a low leakage rate, in the case of liquid media in particularly substantial freedom from leaks, high stability and low wear despite application of very different media and in dry running is ensured. Therefore, the rotary union 10 can justifiably be referred to as a multimedia-compatible rotary union, or even as all media-compatible rotary union or universal rotary union.

The media inlet channels 22, 24, in particular for liquid media and gaseous media, are locked with respect to one another by the internal check valves 42, 44. The internal locking by means of the two internal check valves 42, 44 makes it possible for complex external interconnection and further external check valves to be largely omitted. Where required, the rotary union 10 operates with just one single check valve 42, 44 per media inlet channel 22, 24. The integrated check valves 42, 44 in the radial media inlet channels 22, 24 further contribute to simplification for the user.

Furthermore, the control channel 86 unlocks fully, automatically, upon relief of the second media inlet channel 24, such that a reliable, quick and precise switching from the second balance ratio B′ to the first balance ratio B, and vice versa, is ensured. Furthermore, subsequent running out of the media inlet channels can be prevented. Further advantageously, during use of reduced or minimum quantity lubrication via the axial port 36, neither an external check valve nor an external ball valve is required in the external supply line.

Due to the different balance ratios B, B′ of the different media inlet channels 22, 24, 26, adjusted to the respective medium, in the case of a circuit with cooling lubricant or cutting oil or hydraulic oil, a high degree of tightness of the mechanical seal 50, and in the case of compressed-air operation a relatively low air leakage rate in the range of 15-20 standard liters per minute, as well as good dry running properties and high stability can be brought into line with one another. Furthermore, during operation with cooling lubricant, a high pressure, in particular greater than 90 bar, can be used, and the leakage rate nonetheless remains in an acceptable range, or the mechanical seal is substantially leak-free. The embodiment can be operated with liquid media, CL or cutting oil optionally at up to 140 bar, with compressed air up to 10 bar, and with MQL up to 10 bar.

Leakage ports 91 for discharging a slight remaining leakage of cooling lubricant or cutting oil or hydraulic oil are provided at various angles, and can be used depending on the installation position of the rotary union 10. A leakage connection coupling 92 can be connected at the desired leakage port 91, in order to discharge leakage fluid from a leakage chamber 94 outside the mechanical seal 50.

The stationary housing part 12 is preferably formed as a multipart feedthrough housing or multipart rotary union housing, such that, on account of the modular design, simple adaptability to existing housing shapes is possible. In the present example, the stationary housing part 12 consists of a rotor housing 12a, in which the rotor 16 is mounted by means of the ball bearings 14, an intermediate housing part 12b, in which the stator seal ring assembly 52 is mounted in an axially displaceable manner and in which a part of the control channel 86 extends, and a rear housing part 12c, in which the media inlet channels 22, 24, 26 extend. In the present example, the radial media inlet channels 22, 24 comprising the integrated check valves 42, 44 are inserted, for example screwed, into the stationary housing part 12, more precisely into the rear housing part 12c, radially from the outside.

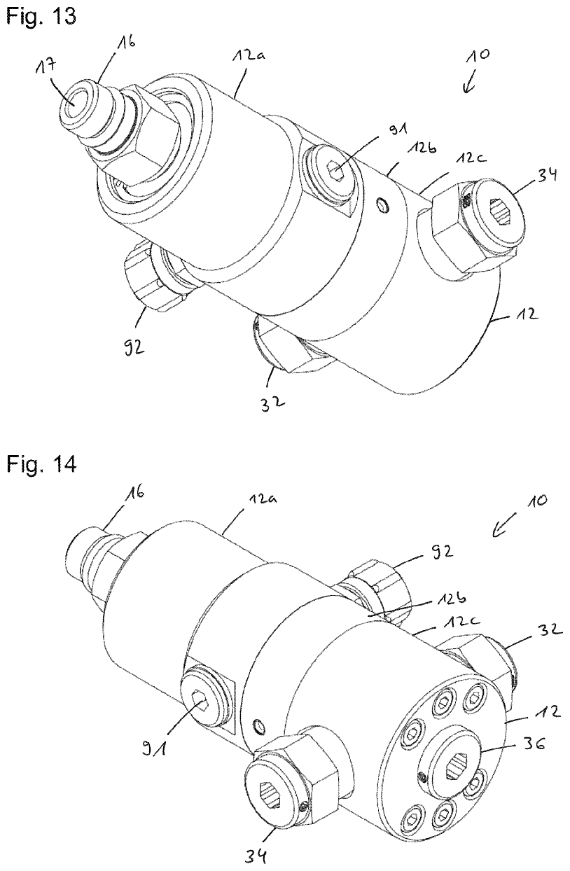

With reference to FIGS. 13 to 14, a slightly smaller embodiment of the rotary union 10 having a narrower stationary housing part 12 is shown, which is also suitable for example for installation in machine tools.

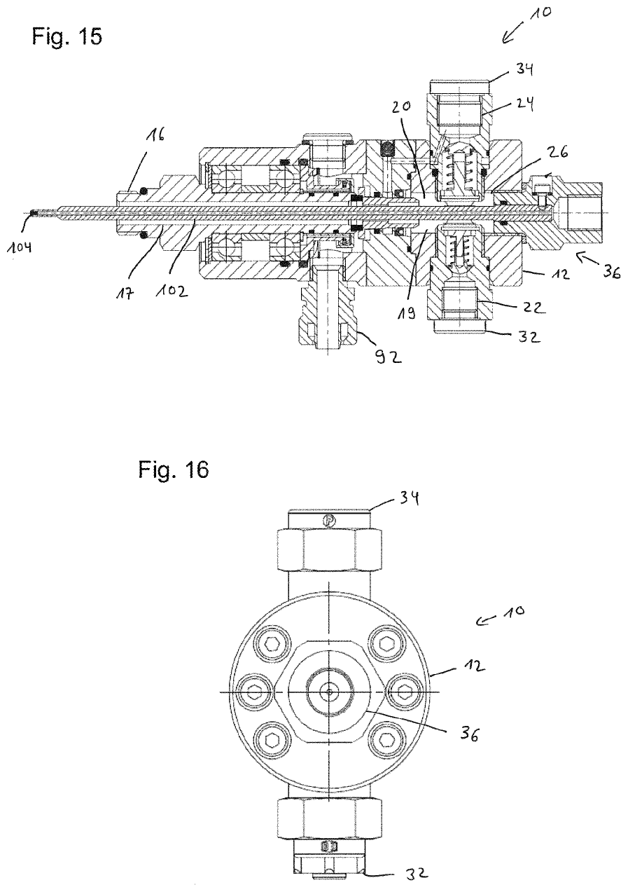

With reference to FIGS. 15 to 16, the rotary union 10 can also be provided with an internal mixing device for aerosol mixing for reduced or minimum quantity lubrication. For this purpose, a lance 102 is inserted and for example screwed into the axial connection port 36. The lance 102 extends coaxially through the axial media inlet channel 26, through the inner fluid channel 20, and into the fluid channel 17 of the rotor 16, and, in the present example, protrudes beyond the rotor 16 and as far as into the machine spindle 15 (cf. FIG. 12). In the case of said lance 102, by way of example, the aerosol for the reduced or minimum quantity lubrication is mixed at the lance outlet opening 104, wherein the lubricant is supplied via the axial port 36 and compressed air via the first port 32.

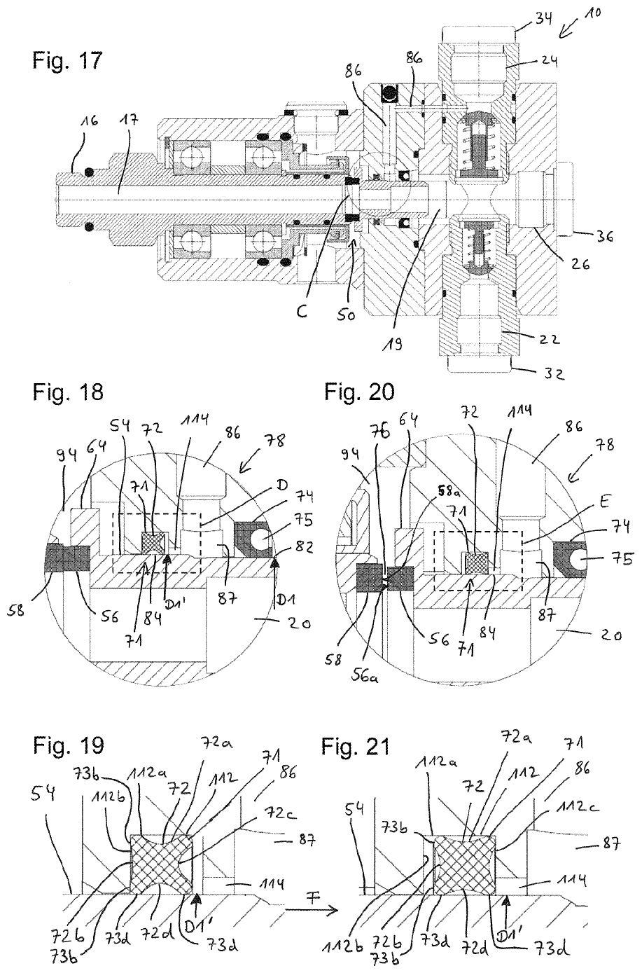

With reference to FIGS. 17 to 21, the secondary seal 78 of the stator seal ring assembly 52 comprises a rotor-side quad ring 72, preferably made of Viton®, and a stator-side elastomer sealing ring 74. The elastomer sealing ring 74 has a U-shaped cross section having a groove 75 that is open to the working space 19, such that the groove 75 can be rinsed during operation. The U-shaped sealing ring 74 is also referred to as a U-cup ring 74.

With reference to FIGS. 17 to 19, the quad ring 72 is preloaded on the rotor-side axial region 84 of the hollow piston 54 having the outside diameter D1′. In this case, the quad ring 72 is accommodated in the stationary housing part 12, in particular in the intermediate housing part 12b, in a groove 112 extending around the hollow piston 54. The quad ring 72 has sufficient clearance, relative to the groove base 112a, in order to be able to move relative to the stationary housing part 12 in the case of an axial displacement of the hollow piston 54 within the groove 112 that is produced having an axial oversize. The quad ring or X-ring 72 forms a lip seal, in particular a multi lip seal.

In the pressurized state shown in FIGS. 17 to 19, the quad ring 72 is pressed, by the hydraulic pressure, against the rotor-side annular wall 112b of the groove 112, and deforms elastically in the process, with its shaping that is concave on four sides, in cross section. In particular, the rotor-side concave end face 72b deforms at the wall 112b. In this case, the hydraulic pressure can act successfully on the concave end face 72c of the quad ring 72 facing away from the rotor, and can move this, together with the hollow piston 54, in the direction of the rotor, and press the quad ring 72 against the annular wall 112b in an elastically deforming manner. Thus, in the case of pressurization of the second media inlet channel 24 and the control channel 86, not only is the higher balance ratio B′ established at the two seal rings 56, 58, in order to achieve an adequate sealing effect, for example during operation using cutting oil or hydraulic oil, but rather the quad ring 72 is also elastically deformed, in cross-section, by pressing by the medium pressure against the side wall 112b. For this purpose, the control channel 86 is fluidically connected to the quad ring groove 112 via a connecting channel 114, such that the hydraulic pressure existing in the control channel 86 can exert an axial force, on the quad ring 72 acting in the direction of the rotor. In the present example, the connecting channel 114 is formed as a peripheral annular groove around the hollow piston 54, in order to uniformly apply hydraulic pressure to the quad ring 72 all around. Furthermore, in the present example, the control channel 86 opens into a control channel groove 87 surrounding the hollow piston 54, in the form of an annular groove, which is in fluidic communication, axially, with the connecting channel 114.

In the case of depressurization of the second media inlet channel 24 and of the control channel 86, the deformation by resilient relaxation of the quad ring 72, in particular of the rotor-side quad ring end face 72b which is concave in the unloaded state, generates an axial force component F facing away from the rotor 16, in that the quad ring 72 presses away from the annular wall 112b by resilient shape recovery. Due to the radial preload of the quad ring 72 on the hollow piston 54, the quad ring 72 transmits, by its resilient shape recovery, the axial force component F to the seal ring carrier 53 or hollow piston 54 away from the rotor 16. In this case, the quad ring 72 sits with its concave inside 72d, with two sealing lips 73d on the outside diameter D1′ of the hollow piston in a preloaded manner, as a result of which a good entrainment is ensured. The quad ring 72 thus carries the hollow piston 54 along axially, in that the force component F, exerted by the resilient shape recovery, from the quad ring 72, acts on the hollow piston 54, and thus at least contributes to opening the mechanical seal 50 upon depressurization of the second media inlet channel 24 and of the control channel 86. At the same time, the outer periphery 72a of the quad ring 72 provides sufficient sealing against the groove base 112a such that, int eh case of pressurization with liquid medium via the control channel 86, the quad ring 72 is pressed, by the medium pressure, against the rotor-side annular wall 112b, and is elastically deformed in the process. In said pressurized elastically deformed state of the quad ring 72, then in particular the rotor-side end face 72b and/or the radial inner side 72d of the quad ring 72 provide sufficient sealing against the rotor-side annular wall 112b or the outside diameter D1′, in order to prevent undesired leakage at the secondary seal 78. Upon pressurization, the quad ring 72 seals, by two sealing lips 73b, against the rotor-side annular wall 112b of the stationary housing part 12, and pushes away from the annular wall 112b again, by the two sealing lips 73b, upon pressure relief. An elastomer ring of this kind advantageously has defined deformation properties.

As a result, the rotary union 10 inter alia has good dry running properties and, in compressed-air operation, a sufficient air gap 76 between the two sealing surfaces 56a, 58a of the preferably used SiC—SiC mechanical seal 50 is ensured, wherein on account of the lower balance ratio B upon pressurization via the first media inlet channel 22 or the axial media inlet channel 26 a low leakage rate is nonetheless ensured.

The open state of the mechanical seal is shown in FIGS. 20 to 21, wherein the air gap 76 may be shown exaggerated for illustration. In the open state, the quad ring 72 can, by contact on the peripheral annular wall 112c of the groove 112 facing away from the rotor, also find a stop for the axial movement of the hollow piston 54 or the stator seal ring assembly 52.

Thus, the quad ring 72 preloaded on the hollow piston 54 moves together with the hollow piston 54 between the closed and open state of the mechanical seal 50, wherein the quad ring 72 moves axially within the annular groove 112 produced having an axial oversize, in particular between the two annular walls 112b, 112c, as is shown possibly exaggerated in FIGS. 18 to 21 for the sake of clarity.

Thus, the first secondary sealing ring, formed in this example as a quad ring 72, forms an elastomer shape-recovery element 71, which contributes to a reliable Pop-off® upon depressurization of the liquid medium. Furthermore, the shape-recovery element 71 can contribute to quick switching processes when switching in particular between pressurization with liquid medium via the second media inlet channel 24 on the one hand, and compressed air via the first or axial media inlet channel 22, 26 on the other hand. The U-cup ring 74 ensures the Pop-off® function after application of compressed air or CL via the first media inlet channel, at the low balance ratio B. Thus, a quick pressure change between the different media inlet channels, without residual pressure in the control line 86, is possible. In this case, the switching between the different balance ratios B and B′ takes place purely mechanically/physically by pressurization with the media introduced in each case, or depressurization.

Due to the shape-recovery element 71 or the secondary seal 78, reliable switching pulses and a relative resistance-free axial displacement of the hollow piston 54 or the floating seal ring 56 can be ensured. In particular, rapid switching changes between the first media inlet channel 22 in the case of pressurization with compressed air, and the second media inlet channel 24 in the case of pressurization with liquid medium, can be ensured.

In summary, a reliable all media-compatible rotary union 10 can be provided, wherein in particular the first media inlet channel 22 is suitable for gaseous media, optionally also for cooling lubricant (CL), the second media inlet channel is suitable for liquid media, in particular for cutting oil and hydraulic oil, but optionally also for cooling lubricant (CL), and the axial third media inlet channel 26 is suitable for reduced or minimum quantity lubrication (RQL/MQL) or an oil-gas aerosol, but optionally also for compressed air or CL. In this case, a high degree of reliability and variability for operation with all the different media is ensured.

Adding the second effective diameter D1′ on the hollow piston 54 increases the balance ratio relative to the first effective diameter D1 from B to B′, such that the sealing surfaces 56a, 58a remain closed or have a sufficiently low leakage rate or operate in a substantially leak-free manner (switching leakage or bleeding), even upon application of higher-viscosity liquid media, such as cutting oil or hydraulic oil.

Since the balance ratio B, in particular in the case of application of compressed air to the first media inlet channel 22, is lower than the balance ratio B′ but higher than in the case of many other rotary unions, a reliable compressed-air operation with a simultaneously low air leakage is ensured.

Thus, different media inlet channels, which bring about different balance ratios of the rotary union 10, said channels having associated media in each case, are connected. The respective balance ratios B and B′, which are assigned to specific media inlet channels, are in turn optimized to the specific media.

The first media inlet channel 22 is in particular designed for compressed air, wherein pressurization with CL is also possible. As soon as compressed air is applied to the first media inlet channel 22, said compressed air flows through the check valve 42 into the working space 19 or the inner fluid channel 20. In this case, the smaller balance ratio B, in the present example preferably of approximately 0.52, is present at the stepped piston 54. Due to the smaller balance ratio B, the gap 76 forms between the seal rings 56, 58, such that excessive wear in dry running, at the sliding surfaces 56a, 58a of the two silicon carbide sealing rings 56, 58, can be prevented.

The second media inlet channel 24 is in particular designed for operation using cutting oil, hydraulic oil, or cooling lubricant. As soon as the media inlet channel 24 is pressurized with the liquid medium, the liquid medium enters the working space 19 or the inner fluid channel 20, and simultaneously the control channel 86, via the check valve 44. Via the control channel 86, the medium applies pressure to the stepped piston 54, as a result of which the larger balance ratio B1′, in this example of approximately 0.66, is brought about. Accordingly, the pressurization of the stepped piston 54 via the control channel 86 brings about a switch of the balance ratio from B to B′, wherein the balance ratio B′ is optimized for liquid media, in particular cutting oil, hydraulic oil, or CL. The check valve 44 has a control pressure of approximately 0.5 bar, such that, as soon as the pressure in the control channel 86 exceeds the control pressure, the liquid medium can flow into the inner fluid channel 20. The floating seal ring 56 is pressed onto the rotor seal ring 58, by the higher balance ratio B′, such that the mechanical seal 50 remains closed and the liquid medium can flow through the rotor 16 in a substantially leak-free manner. After switching off of the medium in the media inlet channel 24, the two seal rings 56, 58 are separated again by the Pop-Off® function, and the control channel 86 is completely relieved of pressure, which can also be referred to as complete unblocking of the control channel 86. In this case, in the present embodiment the Pop-Off® function is assisted by the elastomer shape-recovery element 71, e.g. in the form of the quad ring 72, wherein this is advantageous for the multimedia compatibility of the rotary union 10, but optional.

The embodiment has two different balance ratios B, B′. However, it is also possible to construct a rotary union even having three or more balance ratios.

The axial media inlet channel 26 is optimized for reduced or minimum quantity lubrication (RQL/MQL), wherein operation using compressed air or cooling lubricant (KSS) is also possible. In this case, the third media inlet channel 26 extends axially in a straight line and does not contain any check valves, which is advantageous in order that the aerosol does not demix, or demixes as little as possible. Upon pressurization of the third axial media inlet channel 26 with reduced or minimum quantity lubrication, the floating seal ring 58 is pressed onto the rotor seal ring 58, at the lower balance ratio B, such that the mechanical seal 50 remains closed and the medium can flow through the rotor 16 in a leak-free manner, but at a lower balance ratio B compared with B′. After switching off of the medium in the axial media inlet channel 26, in turn the mechanical seal 50 opens, i.e. the seal rings 56, 58 are separated by the Pop-Off® function, here brought about in particular by a resilient shape recovery of the U-cup ring 74.

It is again noted that the multimedia compatibility or the switching of the balance ratio on the one hand, and the use of the quad ring 72 on the other hand, in combination, offers synergistic advantages, but these two aspects of the present disclosure can also be implemented separately. Thus, for example, the quad ring 72, even in conventional rotary unions, can be used with just one fixed balance ratio (cf. also EP 1 744 502 or EP 2 497 978) and/or with just one media connection port, as an elastomer shape-recovery element 71, and the multimedia compatibility or switching of the balance ratio between two or more different values can in principle also be achieved using conventional secondary sealing rings, such as O-rings.

It is clear for a person skilled in the art that the embodiments described above are to be understood as being by way of example, and the invention is not limited to these, but rather can be varied in a large number of ways, without departing from the scope of protection of the claims. Spatially orienting terms such as front or behind are not to be understood in absolute terms in space, but rather serve to designate the relative relationship of the components, wherein “front” refers to the rotor side, and “behind” or “rear” refers to the axial stator side opposite the rotor. Furthermore, it is clear that, irrespective of whether they are disclosed in the description, the claims, the drawings, or otherwise, the features also define components of the invention that are essential individually, even if they are described together with other features, and the features of the embodiments can be combined with one another.

1. A rotary union for transferring fluid media from a stationary machine part to a rotating machine part, comprising:
a stationary housing part for installation in the stationary machine part, wherein the stationary housing part comprises a working space and at least one media inlet channel, opening into the working space, for introducing fluid media into the stationary housing part,
a rotor for connection to the rotating machine part and having a fluid channel for establishing a fluidic connection to the working space of the stationary housing part,
a mechanical seal between the stationary housing part and the rotor, wherein the mechanical seal comprises a rotor seal ring that rotates together with the rotor, and an axially movable seal ring assembly having a stator seal ring, and
an elastomer shape-recovery element which, upon pressurization with a fluid medium, is pressed axially against a wall of the stationary housing part, by a pressure of the fluid medium, and deforms elastically in the process, and wherein the elastomer shape-recovery element resiliently recovers its shape upon depressurization and presses away from the wall by the resilient shape recovery, and in the process pulls the seal ring assembly away from the rotor, in order to open the mechanical seal.

2. The rotary union according to claim 1, further comprising a secondary seal, configured to seal the axially movable seal ring assembly in the stationary housing part, wherein the elastomer shape-recovery element forms a first secondary sealing ring of the secondary seal.

3. The rotary union according to claim 2, further comprising a control channel extending in the stationary housing part, which control channel opens at an outside diameter of the axially movable seal ring assembly, in order to pressurize the axially movable seal ring assembly at its outside diameter with a fluid medium, wherein the secondary seal comprises a second secondary sealing ring, wherein the first and second secondary sealing rings are arranged on axially opposing sides of the control channel, in order to seal the control channel axially on both of the axially opposing sides.

4. The rotary union according to claim 3, wherein at least one of the second secondary sealing ring being an elastomer ring having a U-shaped cross section, and the first and second secondary sealing rings having different inside diameters.

5. The rotary union according to claim 3, wherein the elastomer shape-recovery element is arranged between the control channel and the stator seal ring and seals the control channel on a rotor side of the control channel.

6. The rotary union according to claim 1, wherein the elastomer shape-recovery element is preloaded on an outside diameter of the axially movable seal ring assembly.

7. The rotary union according to claim 1, wherein the elastomer shape-recovery element is axially displaceable, at an outside diameter of the elastomer shape-recovery element, relative to the stationary housing part.

8. The rotary union according to claim 1, wherein the stationary housing part comprises a peripheral groove, having an axial oversize, for the elastomer shape-recovery element, in which groove the elastomer shape-recovery element is accommodated, wherein the elastomer shape-recovery element has axial clearance, for axial mobility, in the groove.

9. The rotary union according to claim 8, wherein the peripheral groove has a radially outer peripheral groove base, and the elastomer shape-recovery element is axially displaceable relative to the outer peripheral groove base.

10. The rotary union according to claim 1, wherein the axially movable seal ring assembly comprises a seal ring carrier which is axially movably mounted in the stationary housing part with the elastomer shape-recovery element and on a rotor-side end face of which the stator seal ring is fastened, and wherein the elastomer shape-recovery element is preloaded on an outside diameter of the seal ring carrier.

11. The rotary union according to claim 10, further comprising a control channel and a control channel groove surrounding the seal ring carrier, in order to apply a medium pressure peripherally to the seal ring carrier, and wherein the control channel groove is fluidically connected to a groove for the elastomer shape-recovery element, and wherein, upon pressurization of the control channel with a medium, the medium pressure is applied to the elastomer shape-recovery element on an axial end face of the elastomer shape-recovery element facing away from the rotor, wherein the medium pressure brings about an axial force on the axial end face of the elastomer shape-recovery element, facing away from the rotor, in the direction of the rotor.

12. The rotary union according to claim 1, wherein at least one of the following conditions are fulfilled:
an axial end face of the elastomer shape-recovery element facing the rotor is concavely shaped,
upon pressurization with a medium, the axial end face of the elastomer shape-recovery element facing the rotor rests in an annular manner on the wall of the stationary housing part, at least with two first sealing lips,
upon depressurization, the elastomer shape-recovery element pushes away from the wall of the stationary housing part, by resilient shape recovery of the at least two first sealing lips,
an axial end face of the elastomer shape-recovery element facing away from the rotor is concavely shaped,
an inner periphery of the elastomer shape-recovery element is concavely shaped, and
the elastomer shape-recovery element rests annularly, in a preloaded manner, on the axially movable seal ring assembly, with at least two second sealing lips.

13. The rotary union according to claim 1, wherein under pressurization with a medium, the axially movable seal ring assembly is pressed against the rotating rotor seal ring, and the elastomer shape-recovery element undergoes elastic deformation of a cross section of the elastomer shape-recovery element in the process, and wherein under depressurization, a restoring force brought about by the elastic deformation of the cross section of the elastomer shape-recovery element at least contributes to the axially movable seal ring assembly detaching from the rotor seal ring, wherein an air gap results between the stator seal ring and the rotor seal ring, allowing frictionless dry running of the rotary union.

14. The rotary union according to claim 1, wherein the elastomer shape-recovery element is a quad.

15. A rotary union for transferring fluid media from a stationary machine part to a rotating machine part, comprising:
a stationary housing part for installation in the stationary machine part, wherein the stationary housing part comprises a working space and at least one media inlet channel, opening into the working space, for introducing fluid media into the stationary housing part,
a rotor for connection to the rotating machine part and having a fluid channel for establishing a fluidic connection to a working space of the stationary housing part,
a mechanical seal between the stationary housing part and the rotor, wherein the mechanical seal comprises a rotor seal ring that rotates together with the rotor, and a stator seal ring,
a secondary seal, and
wherein the secondary seal comprises a quad ring.
